(19) United States
(12) Patent Application Publication
(10) Pub. No.: US 2026/0110832 A1
(43) Pub. Date: Apr. 23, 2026

(54) LIGHT GUIDE PLATE, LIGHT SOURCE MODULE AND DISPLAY APPARATUS

(71) Applicant: Coretronic Corporation, Hsin-Chu (TW)

(72) Inventors: Tzeng-Ke Shiau, Hsin-Chu (TW); Ying-Shun Syu, Hsin-Chu (TW); Wen-Yen Chiu, Hsin-Chu (TW); Chia-Liang Kang, Hsin-Chu (TW)

(73) Assignee: Coretronic Corporation, Hsin-Chu (TW)

(21) Appl. No.: 19/357,059

(22) Filed: Oct. 13, 2025

(30) Foreign Application Priority Data
Oct. 23, 2024 (CN) 202411484185.8
Sep. 19, 2025 (CN) 202511343288.7

(51) Int. Cl. F21V 8/00

(52) U.S. Cl. CPC G02B 6/0036

(57) ABSTRACT

A light guide plate including a plate body and a plurality of optical microstructures is provided. The plate body has a first surface. The plurality of optical microstructures are formed on the first surface of the plate body. Each of the plurality of optical microstructures has an optical curved surface and a plurality of optical reference surfaces configured to divide the optical curved surface. The plurality of optical reference surfaces are perpendicular to the first surface. Intersections of the optical curved surface and the plurality of optical reference surfaces respectively form a plurality of optical profile lines. An optical angle is formed between the first surface and each of the plurality of optical profile lines, and angles of at least part of the optical angles are different from each other. A light source module and a display apparatus adopting the light guide plate are also provided.

### CROSS-REFERENCE TO RELATED APPLICATION

This application claims the priority benefit of China application serial no. 202411484185.8, filed on Oct. 23, 2024, and China application serial no. 202511343288.7, filed on Sep. 19, 2025. The entirety of each of the above-mentioned patent applications is hereby incorporated by reference herein and made a part of this specification.

### BACKGROUND

### Technical Field

The disclosure relates to an optical element and an optical apparatus, and in particular to a light guide plate, a light source module and a display apparatus.

### Description of Related Art

Current electronic devices mostly use flat display modules to display images, among which the technology of liquid crystal display modules is relatively proficient and popular. However, since a display panel of the liquid crystal display module cannot emit light on its own, a backlight module is provided under the display panel to provide light beams required to display an image. In order to provide the display apparatus with a light and thin appearance, most mainstream products currently adopt an edge-lit backlight module. The edge-lit backlight module uses a light guide plate to guide light beams emitted by a light source disposed on a light incident side surface of the light guide plate toward a light emergent surface of the light guide plate, so as to form a surface light source. Optical microstructures may be formed on the surface of the light guide plate to improve the light uniformity and the brightness of the light guide plate, so as to improve the light emergent efficiency and the optical quality of the backlight module.

Generally speaking, a light-receiving surface of an optical microstructure of a light guide plate has a fixed optical angle. Since the optical angle thereof is substantially the same for incident light entering at different angles, the incident light has a larger exit angle via the optical microstructure, such that the light guide plate has good optical efficiency. Meanwhile, as the light incident side of the light guide plate is approached, the number of optical microstructures required to be disposed correspondingly decreases, so that the backlight module has high light emission uniformity. However, if a shading degree of a film on an upper side of the light guide plate is insufficient, different distribution densities of the optical microstructures may easily cause a light spot (Mura) phenomenon on the light emitting surface, thereby affecting light emission uniformity of the backlight module. On the other hand, since a change in a traveling direction of emergent light beams via the optical microstructures is relatively single, a hot spot phenomenon of a plurality of bright regions and dark regions caused by a plurality of light-emitting diodes arranged beside the light incident surface of the light guide plate is also difficult to eliminate.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a light guide plate with good optical performance.

The disclosure provides a light source module with good optical performance.

The disclosure provides a display apparatus with good optical performance and cost advantages, and excellent operational stability and reliability.

Other objectives and advantages of the disclosure may be further understood from the technical features of the disclosure.

In order to achieve one, a part, or all of the above objectives or other objectives, an embodiment of the disclosure provides a light guide plate. The light guide plate includes a plate body and a plurality of optical microstructures. The plate body has a first surface. The plurality of optical microstructures are formed on the first surface of the plate body. Each of the plurality of optical microstructures has an optical curved surface and a plurality of optical reference surfaces configured to divide the optical curved surface. The plurality of optical reference surfaces are perpendicular to the first surface. A plurality of orthographic projections of the plurality of optical reference surfaces on the first surface intersect at a reference point. A plurality of optical profile lines are formed by a plurality of intersections of the optical curved surface and the plurality of optical reference surfaces respectively. An optical angle is formed between each of the plurality of optical profile lines and the first surface. Angles of the optical angles of at least part of the plurality of optical profile lines are different from each other.

In order to achieve one, a part, or all of the above objectives or other objectives, an embodiment of the disclosure provides a light source module. The light source module includes a light source and the light guide plate. The light guide plate includes a plate body and a plurality of optical microstructures. The plate body has a light incident surface and a first surface. The light source is disposed adjacent to the light incident surface. A plurality of optical microstructures are formed on the first surface of the plate body. Each of the plurality of optical microstructures has an optical curved surface and a plurality of optical reference surfaces configured to divide the optical curved surface. The plurality of optical reference surfaces are perpendicular to the first surface. A plurality of orthographic projections of the plurality of optical reference surfaces on the first surface intersect at a reference point. A plurality of optical profile lines are formed by a plurality of intersections of the optical curved surface and the plurality of optical reference surfaces respectively. An optical angle is formed between the first surface and each of the plurality of optical profile lines. Angles of the optical angles of at least part of the plurality of optical profile lines are different from each other.

In order to achieve one, a part, or all of the above objectives or other objectives, an embodiment of the disclosure provides a display apparatus. The display apparatus includes a display panel and a light source module. The light source module is disposed overlapping the display panel and includes a plate body, a light source and a plurality of optical microstructures. The plate body has a light incident surface and a first surface connected to each other. The light source is disposed adjacent to the light incident surface. The plurality of optical microstructures are formed on the first surface of the plate body. Each of the plurality of optical microstructures has an optical curved surface and a plurality of optical reference surfaces configured to divide the optical curved surface. The plurality of optical reference surfaces are perpendicular to the first surface. A plurality of orthographic projections of the plurality of optical reference surfaces on the first surface intersect at a reference point. A plurality of optical profile lines are formed by a plurality of intersections of the optical curved surface and the plurality of optical reference surfaces respectively. An optical angle is formed between the first surface and each of the plurality of optical profile lines. Angles of the optical angles of at least part of the plurality of optical profile lines are different from each other.

Other objectives, features, and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a structural schematic diagram of a light source module according to an embodiment of the disclosure.

FIG. 2A is a schematic diagram of an optical microstructure on a light guide plate of FIG. 1.

FIG. 2B is an enlarged schematic diagram of a partial region of the light guide plate of FIG. 2A.

FIG. 2C is a structural schematic diagram of the optical microstructure of FIG. 2A.

FIG. 2D is a detailed schematic diagram of the optical microstructure of FIG. 2C.

FIG. 3A to FIG. 3C are schematic diagrams of an optical path when an incident light beam passes through the optical microstructure of FIG. 2C.

FIG. 3D is a light pattern distribution diagram when looking at the light guide plate of FIG. 2A at different viewing angles.

FIG. 4A is a schematic diagram of an optical microstructure on another light guide plate of FIG. 1.

FIG. 4B is an enlarged schematic diagram of a partial region of the light guide plate of FIG. 4A.

FIG. 4C is a structural schematic diagram of the optical microstructure of FIG. 4A.

FIG. 4D is a detailed schematic diagram of the optical microstructure of FIG. 4C.

FIG. 5 is a light pattern distribution diagram when looking at the light guide plate of FIG. 4A at different viewing angles.

FIG. 6A is a schematic diagram of an optical microstructure on another light guide plate of FIG. 1.

FIG. 6B is an enlarged schematic diagram of a partial region of the light guide plate of FIG. 6A.

FIG. 7A to FIG. 11 are structural schematic diagrams of an optical microstructure according to different embodiments of the disclosure.

FIG. 12 is a cross-sectional schematic view of a display apparatus according to an embodiment of the disclosure.

FIG. 13 is a cross-sectional schematic view of a display apparatus according to another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Unless limited otherwise, the terms “connected,” “coupled,” and “mounted,” and variations thereof herein are used broadly and encompass direct and indirect connections, couplings, and mountings. Accordingly, the drawings and descriptions will be regarded as illustrative in nature and not as restrictive.

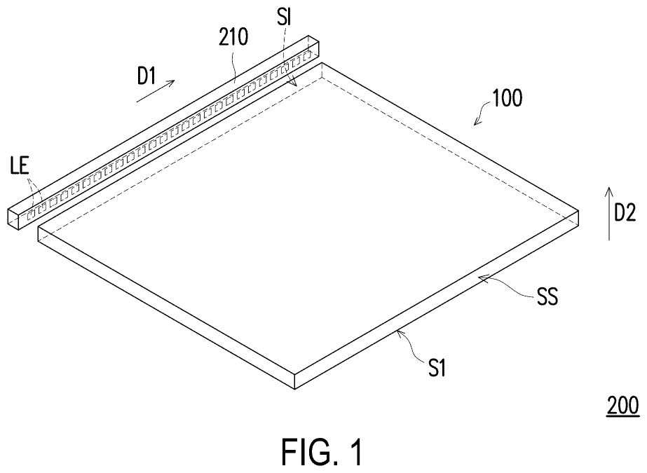

FIG. 1 is a structural schematic diagram of a light source module according to an embodiment of the disclosure. Referring to FIG. 1. A light source module 200 of the embodiment includes a light guide plate 100 and a light source 210. The light source 210 has at least one light emitting element LE and is adapted to provide multiple light beams L. For example, in the embodiment, the light source 210 may be a light bar including a light emitting diode (LED) element or other types of light emitting elements and is adapted to provide light beams. The light source module 200 of the embodiment may serve as an illumination light source of a non-self-emissive display panel (e.g., a liquid crystal display panel, but the disclosure is not limited thereto). For example, the non-self-emissive display panel may be a transmissive liquid crystal display panel, and the light source module 200 may serve as a backlight module of the transmissive liquid crystal display panel, but the disclosure is not limited thereto.

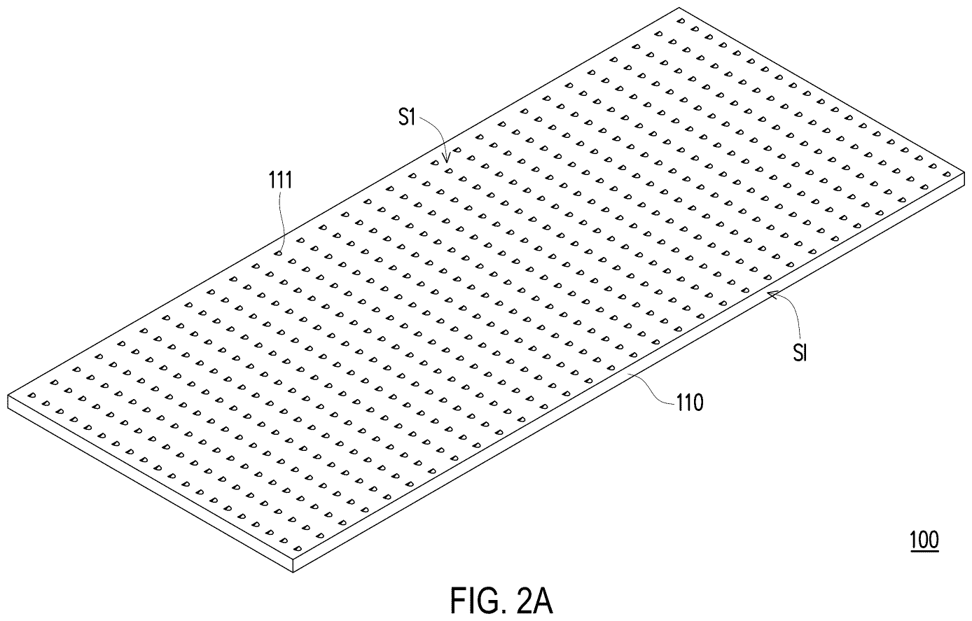

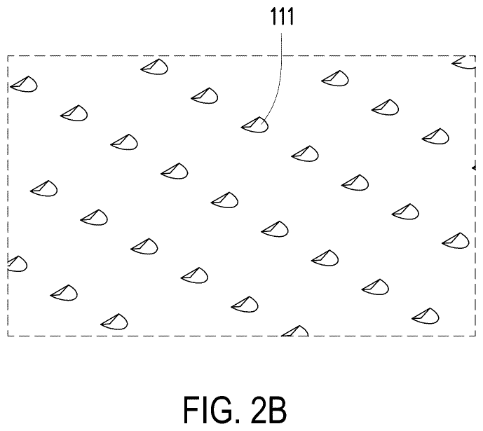

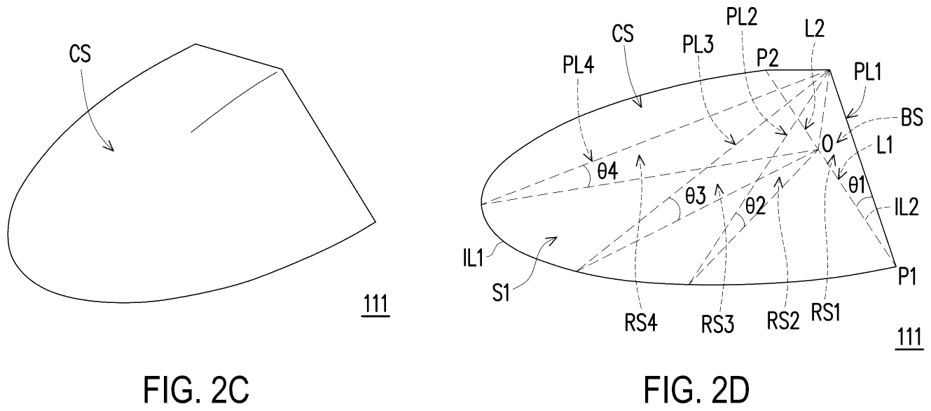

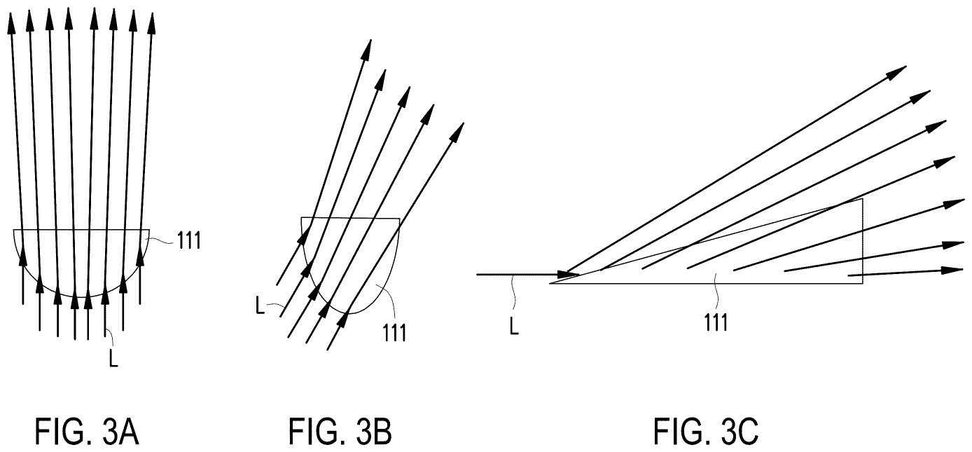

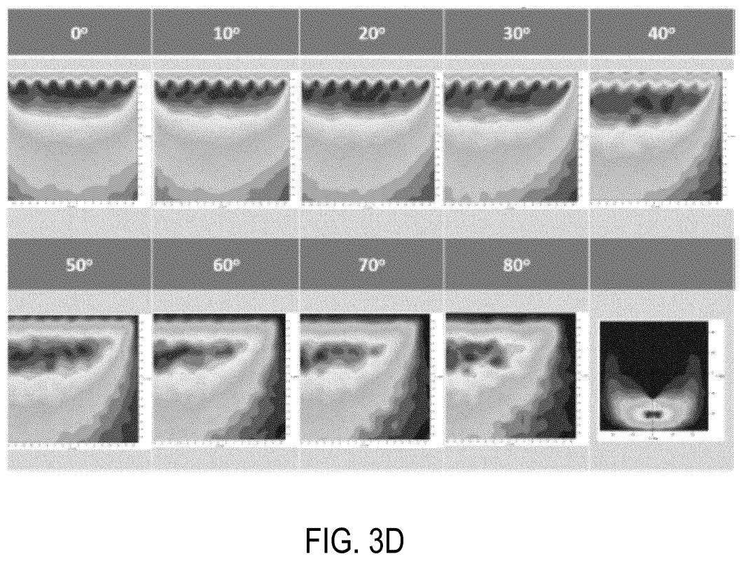

The detailed structure of the light guide plate will be further explained below with reference to FIG. 2A to FIG. 3D.

FIG. 2A is a schematic diagram of an optical microstructure on a light guide plate of FIG. 1. FIG. 2B is an enlarged schematic diagram of a partial region of the light guide plate of FIG. 2A. FIG. 2C is a structural schematic diagram of the optical microstructure of FIG. 2A. FIG. 2D is a detailed schematic diagram of the optical microstructure of FIG. 2C. FIG. 3A to FIG. 3C are schematic diagrams of an optical path when an incident light beam passes through the optical microstructure of FIG. 2C. FIG. 3D is a light pattern distribution diagram when looking at the light guide plate of FIG. 2A at different viewing angles. Specifically, as shown in FIG. 1 to FIG. 2D, in the embodiment, the light guide plate 100 includes a plate body 110 and multiple optical microstructures 111. The plate body 110 has a light incident surface SI, a first surface S1, and a side surface SS. The first surface S1 connects the light incident surface SI and the side surface SS, and the light incident surface SI and the side surface SS are opposite to each other. The optical microstructures 111 are formed on the first surface S1 of the plate body 110. In addition, as shown in FIG. 1, in the embodiment, a first direction D1 is parallel to an extension direction of the light source 210, and a second direction D2 is substantially perpendicular to the first surface S1 of the plate body 110 of the light guide plate 100.

Furthermore, as shown in FIG. 2C and FIG. 2D, in the embodiment, each of the optical microstructures 111 has an optical curved surface CS and multiple optical reference surfaces RS1, RS2, RS3, and RS4 configured to divide the optical curved surface CS. The optical reference surfaces RS1, RS2, RS3, and RS4 are perpendicular to the first surface S1, and when looking down at the first surface S1, a plurality of orthographic projections of the optical reference surfaces RS1, RS2, RS3, and RS4 on the first surface S1 intersect at a reference point O. In the embodiment, the optical curved surface CS is a part of an elliptic cone surface, and the reference point O is a central point of a bottom surface of an elliptic conical surface, but the disclosure is not limited thereto.

In the embodiment, each of the optical microstructures 111 further has an optical surface BS opposite to the optical curved surface CS. The optical curved surface CS and the first surface S1 intersect at a first intersection line IL1. The optical surface BS and the first surface S1 intersect at a second intersection line IL2. The first intersection line IL1 and the second intersection line IL2 intersect at a first endpoint P1 and a second endpoint P2 on the first surface S1. More specifically, in the embodiment, the first intersection line IL1 of each optical microstructure 111 is a semi-elliptic curve, a minimum distance from the central point of the first intersection line IL1 of the optical microstructure 111 to the second intersection line IL2 is a semi-long axis of the semi-elliptic curve, and the second intersection line IL2 of the optical microstructure 111 is a short axis of the semi-elliptic curve.

In the embodiment, in one of the optical microstructures 111, the first endpoint P1 and the reference point O form a first connection line L1, the second endpoint P2 and the reference point O form a second connection line L2, and an included angle between the first connection line L1 and the second connection line L2 is greater than 60 degrees. For example, in the embodiment, since the second intersection line IL2 of the optical microstructure 111 is the short axis of the semi-elliptic curve, an included angle between the first connection line L1 and the second connection line L2 is 180 degrees, but the disclosure is not limited thereto. In other embodiments, the included angle between the first connection line L1 and the second connection line L2 of the optical microstructure 111 may be other angles greater than 60 degrees. For example, the included angle may be an angle such as 80 degrees, 100 degrees, and 120 degrees.

On the other hand, as shown in FIG. 2D, in the embodiment, the intersections between the optical curved surface CS and the optical reference surfaces RS1, RS2, RS3, and RS4 respectively form multiple optical profile lines PL1, PL2, PL3, and PL4. The optical profile lines PL1, PL2, PL3, and PL4 respectively form optical angles θ1, θ2, θ3, and θ4 with the first surface S1. More specifically, as shown in FIG. 2D, in the embodiment, each of the optical profile lines PL1, PL2, PL3, and PL4 is a single straight line segment, and the optical angles θ1, θ2, θ3, and θ4 are included angles formed between the single straight line segments and the first surface S1. Furthermore, as shown in FIG. 2D, in the embodiment, the angles of the optical angles θ1, θ2, θ3, and θ4 of at least part of the optical profile lines PL1, PL2, PL3, and PL4 are different from each other. In other words, any two of the optical angles θ1, θ2, θ3, and θ4 may be different. In the embodiment, the angles of the optical angles θ1, θ2, θ3, and θ4 are greater than or equal to 2 degrees and less than or equal to 70 degrees. Alternatively, the angles of the optical angles θ1, θ2, θ3, and θ4 are greater than or equal to 2 degrees and less than or equal to 60 degrees, or the angles of the optical angles θ1, θ2, θ3, and θ4 are greater than or equal to 2 degrees and less than or equal to 50 degrees.

Moreover, as shown in FIG. 2D, in the embodiment, in one of the optical microstructures 111, one of the optical profile lines PL1, PL2, PL3, and PL4 is closer to the first endpoint P1 or the second endpoint P2 than another one of the optical profile lines PL1, PL2, PL3, and PL4, and the optical angle θ1, θ2, θ3, or θ4 of the one of the optical profile lines PL1, PL2, PL3, and PL4 is greater than the optical angle θ1, θ2, θ3, or θ4 of the another one of the optical profile lines PL1, PL2, PL3, and PL4. In other words, in the embodiment, in one of the optical microstructures 111, the angles of the optical angles θ1, θ2, θ3, and θ4 of the optical profile lines PL1, PL2, PL3, and PL4 gradually decrease as being away from the first endpoint P1 or the second endpoint P2. For example, as shown in FIG. 2D, the relationship between the angles of the optical angles θ1, θ2, θ3, and θ4 is sequentially θ1>θ2>θ3>θ4.

In this way, as shown in FIG. 1 and FIG. 3A to FIG. 3C, in the embodiment, the light source 210 is located next to the light incident surface SI of the light guide plate 100, and the light beams L provided by the light source 210 enter the light guide plate 100 via the light incident surface SI. As shown in FIG. 3A to FIG. 3C, in the embodiment, a surface of the optical microstructure 111 facing the light incident surface SI is the optical curved surface CS, and the optical surface BS of the optical microstructure 111 faces the side surface SS. Therefore, the light beam L incident on the optical microstructure 111 may be diverged via the optical curved surface CS of the optical microstructure 111.

In this way, as shown in FIG. 3A to FIG. 3C, in the embodiment, the optical curved surface CS of the optical microstructure 111 may generate horizontal scattering and vertical scattering of obliquely incident light obliquely incident on the optical microstructure 111 at different angles, and the high light emergent phenomenon at the forward optical angle may be appropriately reduced and scattered light may be generated, so that the light beams L provided by the light source 210 may be scattered at various different angles to achieve diffusion of light beams. Thus, as shown in FIG. 3D, for the light pattern distribution diagram of the light guide plate of FIG. 2A viewed at different viewing angles, the hot spot phenomenon of multiple bright areas and dark areas possibly caused by the light source 210 on the light incident side of the light guide plate 100 may be alleviated or even nearly eliminated.

Moreover, since the optical microstructure 111 may diverge the light beams L incident on the optical microstructure 111, the amount of emitted light per unit area of an orthographic projection of the optical microstructure 111 on the light guide plate 100 is relatively smaller than that of a conventional optical microstructure 111 having a fixed optical angle. Thus, the disposition density of the optical microstructures 111 next to the light incident surface SI of the light guide plate 100 may be increased, and the light source module 200 may still maintain good light uniformity. In this way, the Mura (light spot) phenomenon caused by insufficient shading degree of a film on an upper side of the light guide plate 100 can be avoided, thereby improving optical performance of the light source module 200.

On the other hand, in the embodiment, with differences in a ratio of the length of half of the second intersection line IL2 of the optical microstructure 111 to the minimum distance from the central point of the first intersection line IL1 of the optical microstructure 111 to the second intersection line IL2, the obliquely incident light obliquely incident on the optical microstructure 111 at different angles may also generate different degrees of horizontal scattering and vertical scattering. When the ratio is small, a large horizontal divergence angle is formed, and the larger the ratio, the smaller the horizontal divergence angle of the obliquely incident light. Therefore, the ratio of the optical microstructure 111 may be determined according to the actual situation to control the degree of horizontal scattering of the obliquely incident light. For example, in the embodiment, the ratio of the optical microstructure 111 may be 0.8. In this way, through controlling the ratio of the optical microstructure 111, the optical microstructure 111 may further control the degree of divergence of the light beam L incident on the optical microstructure 111, so that the light source module 200 may further eliminate the mura phenomenon and the hot spot phenomenon on the light incident side, and prevent the generation of the mura phenomenon when the coverage of the upper film of the light guide plate 100 is insufficient, thereby improving the optical performance of the light source module 200.

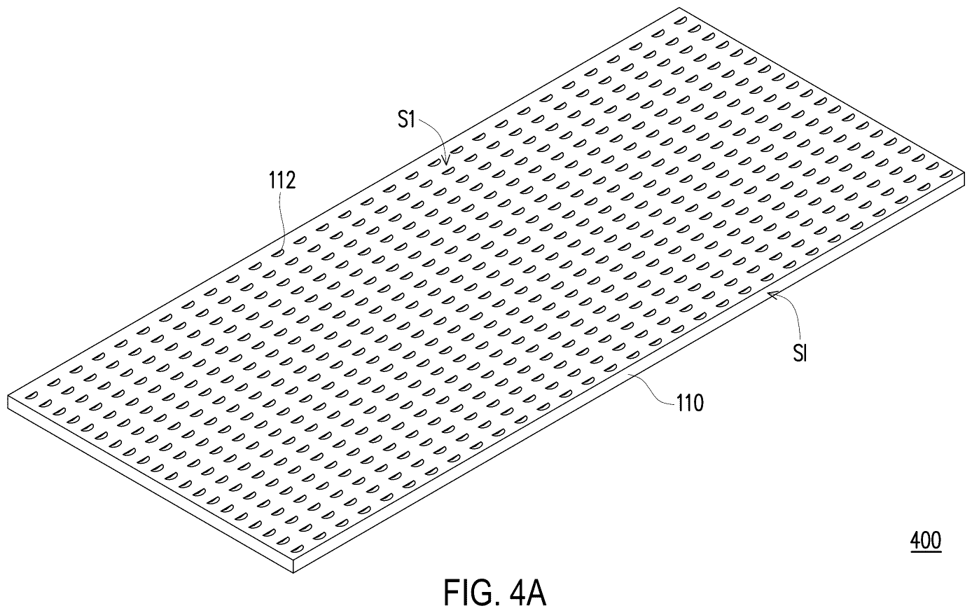

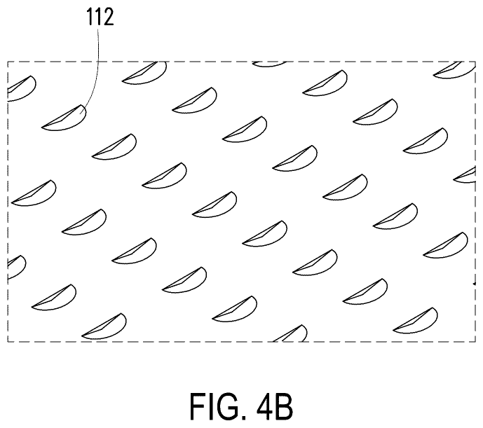

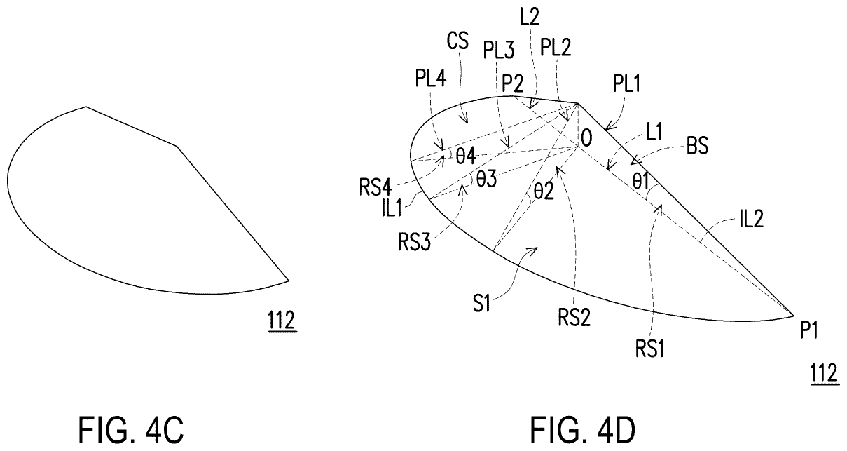

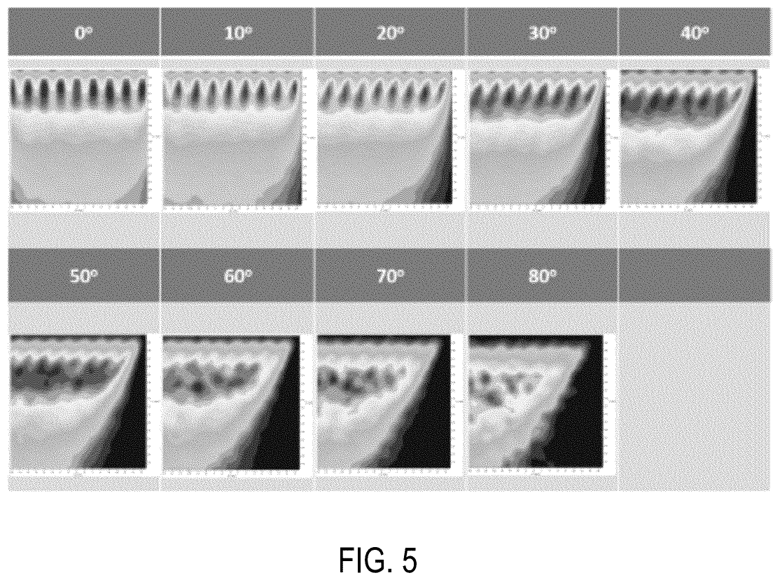

FIG. 4A is a schematic diagram of an optical microstructure on another light guide plate of FIG. 1. FIG. 4B is an enlarged schematic diagram of a partial region of the light guide plate of FIG. 4A. FIG. 4C is a structural schematic diagram of the optical microstructure of FIG. 4A. FIG. 4D is a detailed schematic diagram of the optical microstructure of FIG. 4C. FIG. 5 is a light pattern distribution diagram when looking at the light guide plate of FIG. 4A at different viewing angles. Referring to FIG. 4A to FIG. 5. In the embodiment of FIG. 4A, a light guide plate 400 is similar to the light guide plate 100 of FIG. 2A, and the difference between the two is as follows. As shown in FIG. 4A to FIG. 4D, in the embodiment, the first intersection line IL1 of each optical microstructure 112 on the light guide plate 400 is a semi-elliptic curve, the minimum distance from the central point of the first intersection line IL1 to the second intersection line IL2 is a semi-short axis of the semi-elliptic curve, and the second intersection line IL2 is a long axis of the semi-elliptic curve. For example, in the embodiment, a ratio of the length of half of the second intersection line IL2 of the optical microstructure 112 (i.e., a semi-long axis of the semi-elliptic curve) to the minimum distance from the central point of the first intersection line IL1 of the optical microstructure 112 to the second intersection line IL2 (i.e., the semi-short axis of the semi-elliptic curve) may be 1.2.

Furthermore, as shown in FIG. 4D, in the embodiment, in one of the optical microstructures 112, one of the optical profile lines PL1, PL2, PL3, and PL4 is closer to the first endpoint P1 or the second endpoint P2 than another one of the optical profile lines PL1, PL2, PL3, and PL4, the optical angle θ1, θ2, θ3, or θ4 of the one of the optical profile lines PL1, PL2, PL3, and PL4 is smaller than the optical angle θ1, θ2, θ3, or θ4 of the another one of the optical profile lines PL1, PL2, PL3, and PL4. In other words, in the embodiment, in one of the optical microstructures 112, the angles of the optical angles θ1, θ2, θ3, and θ4 of the optical profile lines PL1, PL2, PL3, and PL4 gradually increase as being away from the first endpoint P1 or the second endpoint P2. For example, as shown in FIG. 4D, the relationship between the angles of the optical angles θ1, θ2, θ3, and θ4 is sequentially θ1<θ2<θ3<θ4.

In this way, the light guide plate 400 may also diverge the light beam L incident on the optical microstructures 112 by the configuration of the optical microstructures 112 with different optical angles θ1, θ2, θ3, and θ4, so that the light guide plate 400 can achieve good optical performance. Moreover, through controlling the ratio of the length of half of the second intersection line IL2 of the optical microstructure 112 to the minimum distance from the central point of the first intersection line IL1 of the optical microstructure 112 to the second intersection line IL2, the optical microstructure 112 may also further control the degree of divergence of the light beam L incident on the optical microstructure 112, so that the light source module 200 may further eliminate the mura phenomenon and the hot spot phenomenon on the light incident side, and the Mura (light spot) phenomenon caused by insufficient shading degree of a film on the upper side of the light guide plate 100 can be avoided, thereby improving the optical performance of the light source module 200. In this way, when the light guide plate 400 is applied to the light source module 200, the light source module 200 may also eliminate the mura phenomenon and the hot spot phenomenon on the light incident side, thereby providing a uniform surface light source 210 with good optical quality, and achieving the aforementioned effects and advantages, which will not be repeated here.

In addition, in the embodiment, since the ratio of the length of half of the second intersection line IL2 of the optical microstructure 112 to the minimum distance from the central point of the first intersection line IL1 of the optical microstructure 112 to the second intersection line IL2 is large, the horizontal divergence angle of the obliquely incident light of the optical microstructure 112 is small. In this way, when the light guide plate 400 is applied to the light source module 200, the brightness of the light source module 200 may be increased by about 5%.

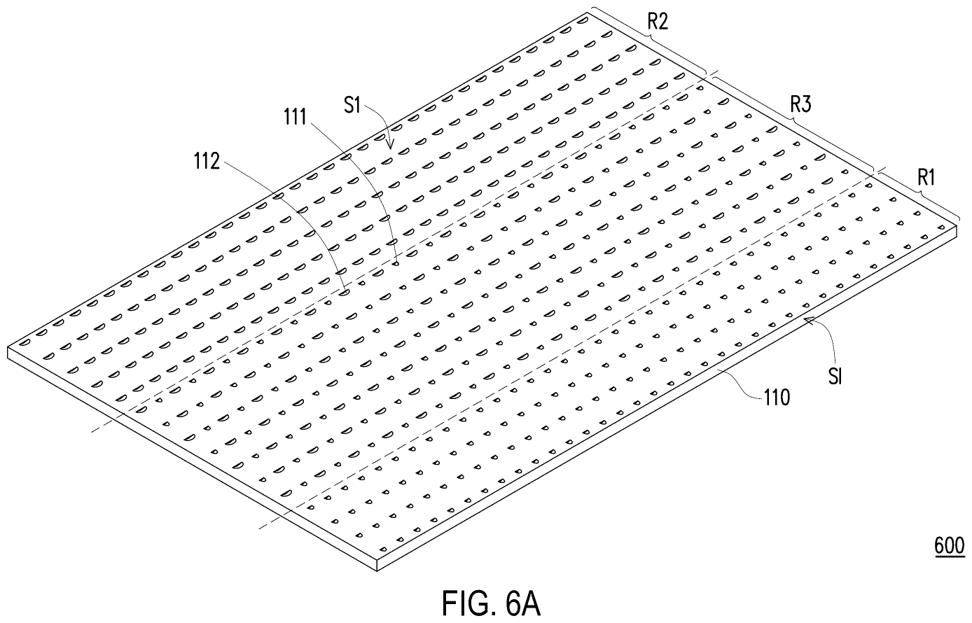

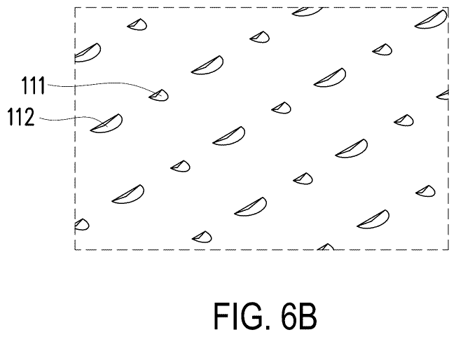

In addition, it is worth noting that in the two aforementioned embodiments, the light guide plates 100 and 400 both have the same optical microstructures as an example, but the disclosure is not limited thereto. In other embodiments, some of the optical microstructures on the light guide plates may also be different, so that different optical microstructures may be mixed and matched to implement improved optical performance. Further explanation will be given below with reference to FIG. 6A and FIG. 6B.

FIG. 6A is a schematic diagram of the optical microstructure 111 on another light guide plate of FIG. 1. FIG. 6B is an enlarged schematic diagram of a partial region of the light guide plate of FIG. 6A. Referring to FIG. 6A and FIG. 6B. In the embodiment of FIG. 6A, a light guide plate 600 is similar to the light guide plate 100 of FIG. 2A, and the difference between the two is as follows. In the embodiment, the light guide plate 600 has a first region R1, a second region R2, and a third region R3. The first region R1 of the light guide plate 600 is closer to the light incident surface SI than the second region R2, and the third region R3 is located between the first region R1 and the second region R2, wherein the first region R1, the second region R2, and the third region R3 are all distributed with a part of multiple optical microstructures. In the embodiment, the optical microstructures include the optical microstructures 111 and the optical microstructures 112, wherein the optical microstructure 111 may be regarded as a first optical microstructure, the optical microstructure 112 may be regarded as a second optical microstructure, and the structure of the first optical microstructure is different from the structure of the second optical microstructure. The first intersection line IL1 of the optical microstructure 111 and the first intersection line IL1 of the optical microstructure 112 are both semi-elliptic curves, and a ratio of the long axis to the short axis of the semi-elliptic curve of the optical microstructure 111 and a ratio of the long axis to the short axis of the semi-elliptic curve of the optical microstructure 112 are different from each other.

Moreover, as shown in FIG. 6A, in the embodiment, the part of the optical microstructures distributed in the first region R1 are the optical microstructures 111, the second intersection line IL2 of the optical microstructure 111 is parallel to the light incident surface SI, the part of the optical microstructures distributed in the second region R2 are the optical microstructures 112, and the second intersection line IL2 of the optical microstructure 112 is parallel to the light incident surface SI. In addition, the part of the optical microstructures distributed in the third region R3 include the optical microstructures 111 and the optical microstructures 112.

In this way, the light guide plate 600 may also diverge the light beam L incident on the optical microstructures 111 and the optical microstructures 112 by the configuration of the optical microstructures 111 and the optical microstructures 112 with different optical angles θ1, θ2, θ3, and θ4, so that the light guide plate 600 can achieve good optical performance. In this way, when the light guide plate 600 is applied to the light source module 200, the light source module 200 may also eliminate the mura phenomenon and the hot spot phenomenon on the light incident side, thereby providing the uniform surface light source 210 with good optical quality, and achieving the aforementioned effects and advantages, which will not be repeated here.

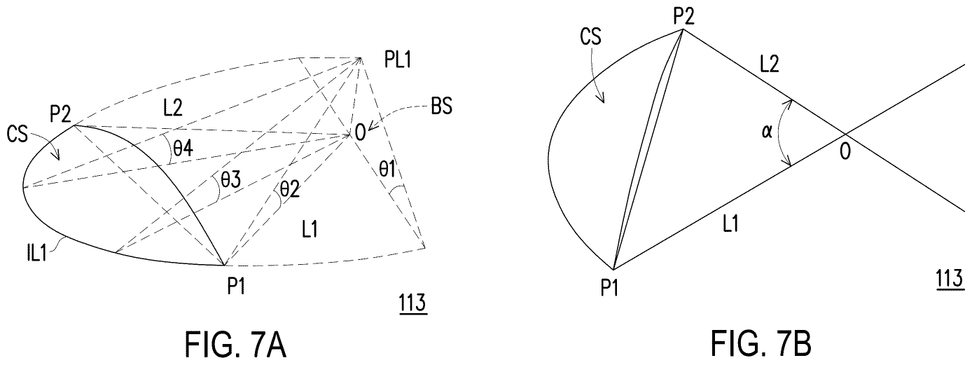

In addition, it is worth noting that in the aforementioned embodiments, although the optical microstructures 111 and/or the optical microstructures 112 on the light guide plates 100, 400, and 600 are exemplified by semi-elliptic cone structures with semi-elliptic cone surfaces, the disclosure is not limited thereto. In other embodiments, the optical microstructure on the light guide plate 100 may also be designed as a structure including a partial elliptic cone surface, and the aforementioned effects and advantages can also be achieved. The following will be further explained with reference to FIG. 7A to FIG. 11.

FIG. 7A to FIG. 11 are structural schematic diagrams of the optical microstructure 111 according to different embodiments of the disclosure.

In the embodiment of FIG. 7A and FIG. 7B, an optical microstructure 113 may be regarded as a microstructure of the optical microstructure 111 after cutting off a partial structure composed of the optical surface BS and a part of the optical curved surface CS connected thereto, wherein the first intersection line IL1 of the optical microstructure 113 is a partial curve segment that forms a semi-elliptic curve. Since an included angle α between the first connection line L1 between the first endpoint P1 of the optical microstructure 113 and the reference point O and the second connection line L2 between the second endpoint P2 and the reference point O is greater than 60 degrees, the obliquely incident light obliquely incident on the optical microstructure 113 at different angles may still generate horizontal scattering and vertical scattering to achieve diffusion of light beams.

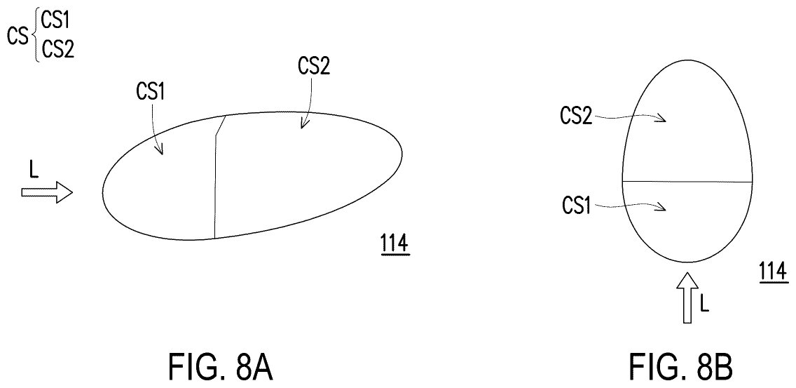

In the embodiment of FIG. 8A and FIG. 8B, an optical microstructure 114 is a combination of the optical microstructure 111 and the optical microstructure 112. As shown in FIG. 8A and FIG. 8B, the optical curved surface CS of the optical microstructure 114 includes a first optical curved surface CS1 and a second optical curved surface CS2, wherein the first optical curved surface CS1 faces the light incident surface SI of the light guide plate 100, and the second optical curved surface CS2 faces the side surface SS of the light guide plate 100. In this way, in the case where the side surface SS of the light guide plate 100 is provided with a reflective plate to increase the optical efficiency of the light guide plate 100, light beams reflected by the reflective plate may also generate horizontal scattering and vertical scattering through the configuration of the second optical curved surface CS2 of the optical microstructure 114 to achieve diffusion of light beams.

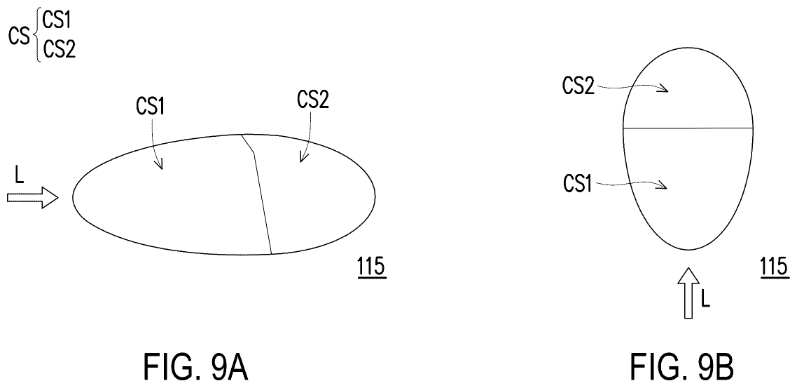

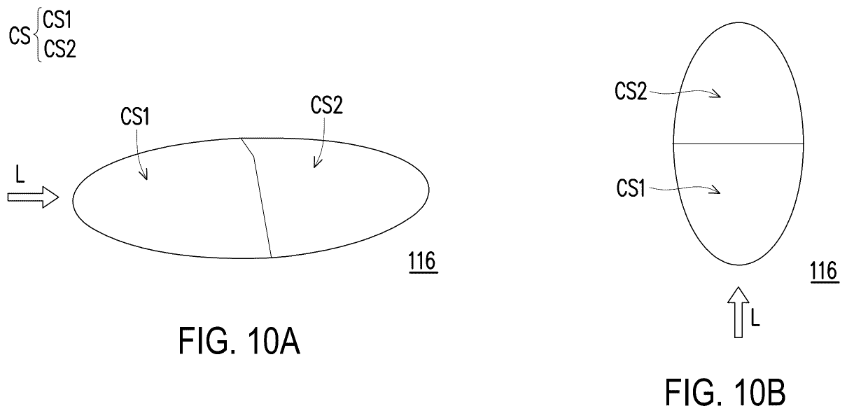

In the embodiment of FIG. 9A to FIG. 10B, optical microstructures 115 and 116 are similar to the optical microstructure 114, and the difference between the three is as follows. In the embodiment of FIG. 8A and FIG. 8B, a connection line formed by an intersection of the first optical curved surface CS1 and the second optical curved surface CS2 is a long axis of a semi-elliptic curve formed by an intersection of the first optical curved surface CS1 and the first surface S1, and is also a short axis of a semi-elliptic curve formed by an intersection of the second optical curved surface CS2 and the first surface S1. In the embodiment of FIG. 9A and FIG. 9B, a connection line formed by the intersection of the first optical curved surface CS1 and the second optical curved surface CS2 of the optical microstructure 115 is a short axis of the semi-elliptic curve formed by the intersection of the first optical curved surface CS1 and the first surface S1, and is also a long axis of the semi-elliptic curve formed by the intersection of the second optical curved surface CS2 and the first surface S1. In the embodiment of FIG. 10A and FIG. 10B, a connection line formed by the intersection of the first optical curved surface CS1 and the second optical curved surface CS2 of the optical microstructure 116 is the short axis of the semi-elliptic curve formed by the intersection of the first optical curved surface CS1 and the first surface S1, and is also the short axis of the semi-elliptic curve formed by the intersection of the second optical curved surface CS2 and the first surface S1. Moreover, in the case where the side surface SS of the light guide plate 100 is provided with a reflective plate to increase the optical efficiency of the light guide plate 100, light beams reflected by the reflective plate may also generate horizontal scattering and vertical scattering through the configuration of the second optical curved surfaces CS2 of the optical microstructures 115 and 116 to achieve diffusion of light beams.

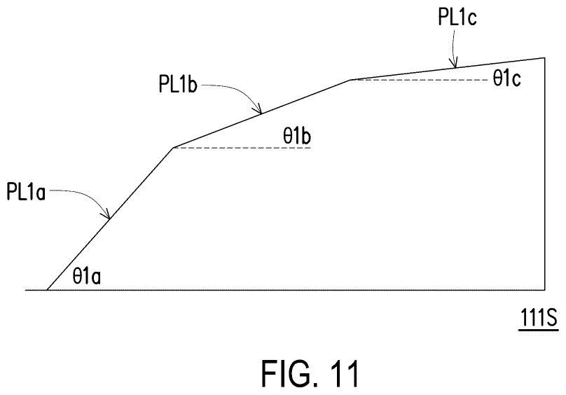

In the embodiment of FIG. 11, an optical microstructure 111S is similar to the optical microstructure 111, and the difference between the two is as follows. In the embodiment of FIG. 11, the optical profile line PL1 of the optical curved surface CS of the optical microstructure 111S is composed of multiple straight line segments PL1a, PL1b, and PL1c, and the optical angle θ1 is an average value of included angles θ1a, θ1b, and θ1c formed between the straight line segments PL1a, PL1b, and PL1c and the first surface S1. In addition, the optical profile lines PL2, PL3, and PL4 may also be composed of multiple straight line segments, and the optical angles θ2, θ3, and θ4 thereof may also be average values of included angles formed between the straight line segments and the first surface S1.

Moreover, since the optical microstructures 113, 114, 115, 116, and 111S all have the optical curved surfaces, when being applied to the light guide plates 100, 400, and 600 to replace the optical microstructures 111 and 112, the light guide plates 100, 400, and 600 may still achieve the aforementioned functions and effects, and other relevant details will not be repeated here.

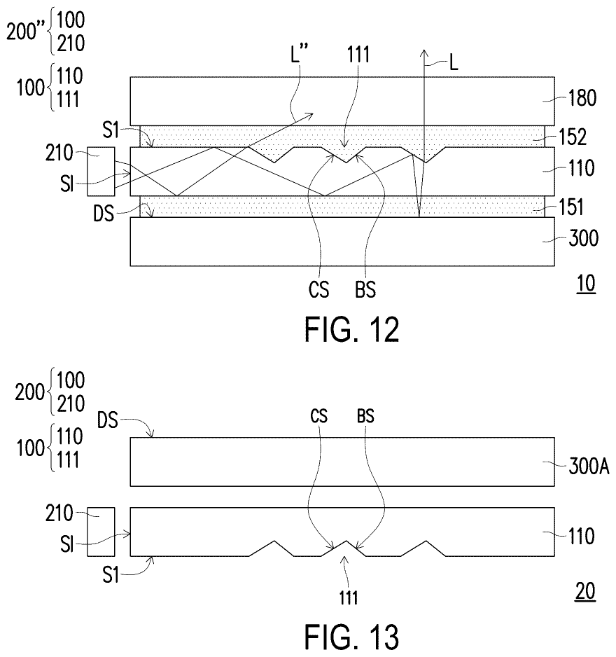

FIG. 12 is a cross-sectional schematic view of a display apparatus according to an embodiment of the disclosure. Referring to FIG. 12, a display apparatus 10 may include a display panel 300 and a light source module 200″, wherein the light source module 200″ is disposed on one side of a display surface DS of the display panel 300. More specifically, the light source module 200″ of the embodiment serves as a front light module of the display panel 300. The display panel 300 may be, for example, a reflective or transflective liquid crystal display panel, an electrophoretic display panel, or an electrowetting display panel.

The composition of the light source module 200″ is similar to that of the light source module 200 of FIG. 1, and detailed description thereof can be found in the relevant paragraphs of the foregoing embodiments, which will not be repeated herein. In the embodiment, the first surface S1 of the plate body 110 of the light guide plate 100 of the light source module 200″ faces away from the display surface DS of the display panel 300. That is, the plurality of optical microstructures 111 of the light guide plate 100 are disposed on one side of the plate body 110 facing away from the display panel 300. For example, the light guide plate 100 may be attached to the display surface DS of the display panel 300 via an optical adhesive layer 151, wherein the material of the optical adhesive layer 151 may include optical clear adhesive (OCA) or optical clear resin (OCR), but the disclosure is not limited thereto.

Furthermore, the display apparatus 10 may further include a transparent cover plate 180 disposed on one side of the first surface S1 of the plate body 110. The transparent cover plate 180 may be attached to the plate body 110 of the light guide plate 100 via an optical adhesive layer 152. That is, the optical adhesive layer 152 connects the transparent cover plate 180 and the first surface S1 of the plate body 110. The material of the transparent cover plate 180 may include glass, polycarbonate (PC), polymethyl methacrylate (PMMA), transparent polyethylene terephthalate (PET), cyclo-olefin polymer (COP), cyclo-olefin copolymer (COC), a combination thereof, or other suitable transparent plate materials. It should be particularly noted that the optical adhesive layer 152 directly and entirely covers respective optical curved surfaces CS and optical surfaces BS of the plurality of optical microstructures 111 of the light guide plate 100. Specifically, when the plurality of optical microstructures 111 are recessed structures of the plate body 110 recessed from the first surface S1, the term “cover” herein refers to the optical adhesive layer 152 filling in the recessed structures formed by the optical curved surfaces CS and the optical surfaces BS, but the disclosure is not limited thereto. The material of the optical adhesive layer 152 may include optical clear adhesive (OCA) or optical clear resin (OCR), but the disclosure is not limited thereto.

Normally, after the light beam L emitted from the light source 210 propagates laterally within the plate body 110, it is reflected by the optical curved surface CS of the optical microstructure 111 toward the display surface DS of the display panel 300. However, a portion of the light beam L″ escapes from the first surface S1 of the plate body 110 during propagation and leaks out of the light guide plate 100 as ineffective light, thereby causing deterioration in light energy utilization efficiency and reduction in display contrast. In order to solve the above problem, most existing display apparatuses adopt an optical adhesive layer having a low refractive index (e.g., a refractive index less than 1.40) to bond the transparent cover plate 180 and the plate body 110. However, the optical adhesive layer with the low refractive index not only has a high unit price but also suffers from insufficient adhesion, which easily causes delamination and reliability problems during manufacturing. This not only reduces overall module stability and production yield but also limits design flexibility of the module.

In the embodiment, since the foregoing optical microstructure 111 has a special structural design capable of efficiently directing the light beam L toward the display surface DS of the display panel 300, the ratio of the ineffective light to the overall emitted light can be effectively reduced, and haze or reduction in display contrast caused by the ineffective light within the module can also be effectively suppressed. From another perspective, in the embodiment, since the foregoing optical microstructure 111 already has high efficiency of light energy coupling and light emission control capability, the material of the optical adhesive layer 152 for bonding the transparent cover plate 180 and the plate body 110 may be selected from general optical-grade adhesive materials (e.g., those having a refractive index greater than or equal to 1.47 and less than or equal to 1.51). This not only reduces the production cost of the display apparatus 10 but also avoids the problems of insufficient reliability and deteriorated stability associated with the use of low-refractive-index optical adhesive layers. It is particularly noted that even when the optical adhesive layer 152 of the embodiment adopts non-low-refractive-index adhesive material, the light energy utilization efficiency of the light source module 200″ and the display contrast of the display apparatus 10 are still better than those of the conventional technical solution using low-refractive-index optical adhesive material. In some embodiments, depending on different product designs or process requirements, the material of the optical adhesive layer 152 may be selected from optical adhesive materials having a refractive index greater than or equal to 1.40 and less than or equal to 1.51.

Although the optical curved surface CS of the optical microstructure 111 shown in FIG. 12 is disposed facing the light source 210, the disclosure is not limited thereto. In other embodiments, the optical surface BS of the optical microstructure 111 may be disposed facing the light source 210, i.e., the optical curved surface CS is disposed facing away from the light source 210. In the embodiment, each optical microstructure 111 is, for example, a recessed structure recessed from the first surface S1. However, in other embodiments, each optical microstructure may also be a protruding structure protruding from the first surface S1. It is particularly noted that, regardless of whether the optical curved surface CS of the optical microstructure 111 faces the light source 210, or whether the optical microstructure 111 is a recessed structure or a protruding structure, the light energy utilization efficiency of the light source module of the disclosure is better than that of a combination having the same structure but using a low-refractive-index optical adhesive material.

On the other hand, the optical microstructures in the foregoing embodiments may also be used to replace the optical microstructures 111 of the embodiment to achieve the aforesaid functions and effects, and relevant details will not be repeated herein.

FIG. 13 is a cross-sectional schematic view of a display apparatus according to another embodiment of the disclosure. Different from the display apparatus 10 of FIG. 12, a light source module 200 of a display apparatus 20 of the embodiment is disposed on one side of a display panel 300A facing away from a display surface DS, wherein the display panel 300A may be, for example, a transmissive liquid crystal display panel, but the disclosure is not limited thereto. That is, the light source module 200 of the embodiment may serve as a backlight module of the display panel 300A. In the embodiment, the first surface S1 of the plate body 110 of the light guide plate 100 faces away from the display panel 300A, i.e., the plurality of optical microstructures 111 are formed on one side of the plate body 110 facing away from the display panel 300A.

In summary, the embodiments of the disclosure have at least one of the following advantages or effects. In a light source module and a display apparatus according to an embodiment of the disclosure, the light guide plate can achieve good optical performance by the configuration of the optical microstructures with different optical angles on the plate body. Therefore, the light source module employing the aforesaid light guide plate can improve a light spot phenomenon on a light emitting surface and a hot spot phenomenon on a light incident side, thereby providing a uniform surface light source with good optical quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of . . . and . . . ” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light guide plate, comprising:
a plate body, having a first surface; and
a plurality of optical microstructures, formed on the first surface of the plate body, wherein each of the plurality of optical microstructures has an optical curved surface and a plurality of optical reference surfaces configured to divide the optical curved surface, the plurality of optical reference surfaces are perpendicular to the first surface, and a plurality of orthographic projections of the plurality of optical reference surfaces on the first surface intersect at a reference point, and a plurality of optical profile lines are formed by a plurality of intersections of the optical curved surface and the plurality of optical reference surfaces respectively, an optical angle is formed between each of the plurality of optical profile lines and the first surface, and angles of the optical angles of at least part of the plurality of optical profile lines are different from each other.

2. The light guide plate according to claim 1, wherein each of the plurality of optical profile lines is a single straight line segment, and the optical angle is an included angle formed between the single straight line segment and the first surface.

3. The light guide plate according to claim 1, wherein each of the plurality of optical profile lines is composed of a plurality of straight line segments, and the optical angle is an average value of included angles formed between the straight line segments and the first surface.

4. The light guide plate according to claim 1, wherein the optical angle is greater than or equal to 2 degrees and less than or equal to 70 degrees.

5. The light guide plate according to claim 1, wherein each of the plurality of optical microstructures further has an optical surface opposite to the optical curved surface, the optical curved surface and the first surface intersect at a first intersection line, the optical surface and the first surface intersect at a second intersection line, and the first intersection line and the second intersection line intersect at a first endpoint and a second endpoint on the first surface.

6. The light guide plate according to claim 5, wherein in one of the plurality of optical microstructures, a first optical profile line of the plurality of optical profile lines is close to the first endpoint or the second endpoint, a second optical profile line of the plurality of optical profile lines is away from the first endpoint or the second endpoint, and the optical angle formed between the first optical profile line and the first surface is greater than the optical angle formed between the second optical profile line and the first surface.

7. The light guide plate according to claim 5, wherein in one of the plurality of optical microstructures, angles of the optical angles formed between the plurality of optical profile lines and the first surface gradually decrease as being away from the first endpoint or the second endpoint.

8. The light guide plate according to claim 5, wherein in one of the plurality of optical microstructures, a first optical profile line of the plurality of optical profile lines is closer to the first endpoint than a second optical profile line of the plurality of optical profile lines, and the optical angle of the first optical profile line is smaller than the optical angle of the second optical profile line.

9. The light guide plate according to claim 5, wherein in one of the plurality of optical microstructures, angles of the optical angles of the plurality of optical profile lines gradually increase as being away from the first endpoint or the second endpoint.

10. The light guide plate according to claim 5, wherein the first intersection line is a semi-elliptic curve, a minimum distance from a central point of the first intersection line to the second intersection line is a semi-long axis of the semi-elliptic curve, and the second intersection line is a short axis of the semi-elliptic curve.

11. The light guide plate according to claim 5, wherein the first intersection line is a semi-elliptic curve, a minimum distance from a central point of the first intersection line to the second intersection line is a semi-short axis of the semi-elliptic curve, and the second intersection line is a long axis of the semi-elliptic curve.

12. The light guide plate according to claim 5, wherein the plurality of optical microstructures includes a plurality of first optical microstructures, the first intersection line of each of the plurality of first optical microstructures is a semi-elliptic curve, a minimum distance from a central point of the first intersection line of each of the plurality of first optical microstructures to the second intersection line of each of the plurality of first optical microstructures is a semi-long axis of the semi-elliptic curve, and the second intersection line of each of the plurality of first optical microstructures is a short axis of the semi-elliptic curve.

13. The light guide plate according to claim 12, wherein the plurality of optical microstructures further includes a plurality of second optical microstructures, the first intersection line of each of the plurality of second optical microstructures is a semi-elliptic curve, a minimum distance from a central point of the first intersection line of each of the plurality of second optical microstructures to the second intersection line of each of the plurality of second optical microstructures is a semi-short axis of the semi-elliptic curve, and the second intersection line of each of the plurality of second optical microstructures is a long axis of the semi-elliptic curve.

14. The light guide plate according to claim 13, further having a first region and a second region, wherein the plate body further has a light incident surface connected to the first surface, the first region of the light guide plate is closer to the light incident surface than the second region, at least part of the plurality of first optical microstructures is distributed in the first region, the second intersection line of each of the plurality of first optical microstructures is parallel to the light incident surface, at least part of the plurality of second optical microstructures is distributed in the second region, and the second intersection line of each of the plurality of second optical microstructures is parallel to the light incident surface.

15. The light guide plate according to claim 14, further having a third region located between the first region and the second region, wherein another part of the plurality of first optical microstructures and another part of the plurality of second optical microstructures are distributed in the third region.

16. The light guide plate according to claim 5, wherein the plurality of optical microstructures includes a first optical microstructure and a second optical microstructure, the first intersection line of the first optical microstructure and the first intersection line of the second optical microstructure are both semi-elliptic curves, and a ratio of a long axis to a short axis of the semi-elliptic curve of the first optical microstructure and a ratio of a long axis to a short axis of the semi-elliptic curve of the second optical microstructure are different from each other.

17. The light guide plate according to claim 5, wherein in one of the plurality of optical microstructures, the first endpoint and the reference point form a first connection line, the second endpoint and the reference point form a second connection line, and an included angle between the first connection line and the second connection line is greater than 60 degrees.

18. The light guide plate according to claim 1, wherein the plate body further has a light incident surface and a side surface connected to the first surface, the light incident surface and the side surface are opposite to each other, the optical curved surface includes a first optical curved surface and a second optical curved surface, the first optical curved surface faces the light incident surface, and the second optical curved surface faces the side surface.

19. A light source module, comprising:
a light source and
a light guide plate, comprising:
a plate body, having a light incident surface and a first surface, wherein the light source is disposed adjacent to the light incident surface; and
a plurality of optical microstructures, formed on the first surface of the plate body, wherein each of the plurality of optical microstructures has an optical curved surface and a plurality of optical reference surfaces configured to divide the optical curved surface, the plurality of optical reference surfaces are perpendicular to the first surface, a plurality of orthographic projections of the plurality of optical reference surfaces on the first surface intersect at a reference point,
a plurality of optical profile lines are formed by a plurality of intersections of the optical curved surface and the plurality of optical reference surfaces respectively, an optical angle is formed between the first surface and each of the plurality of optical profile lines, and angles of the optical angles of at least part of the plurality of optical profile lines are different from each other.

20. A display apparatus, comprising:
a display panel; and
a light source module, disposed overlapping the display panel, and comprising:
a plate body, having a light incident surface and a first surface connected to each other;
a light source, disposed adjacent to the light incident surface; and
a plurality of optical microstructures, formed on the first surface of the plate body, wherein each of the plurality of optical microstructures has an optical curved surface and a plurality of optical reference surfaces configured to divide the optical curved surface, the plurality of optical reference surfaces are perpendicular to the first surface, and a plurality of orthographic projections of the plurality of optical reference surfaces on the first surface intersect at a reference point,
a plurality of optical profile lines are formed by a plurality of intersections of the optical curved surface and the plurality of optical reference surfaces respectively, an optical angle is formed between the first surface and each of the plurality of optical profile lines, and angles of the optical angles of at least part of the plurality of optical profile lines are different from each other.

21. The display apparatus according to claim 20, wherein the display panel has a display surface, and the light source module is disposed on one side of the display surface of the display panel.

22. The display apparatus according to claim 21, wherein the first surface of the plate body faces away from the display surface of the display panel.

23. The display apparatus according to claim 21, further comprising:
a transparent cover plate, disposed on one side of the first surface of the plate body; and
an optical adhesive layer, connecting the transparent cover plate and the first surface of the plate body, wherein the optical adhesive layer directly and entirely covers the optical curved surface of each of the plurality of optical microstructures.

24. The display apparatus according to claim 23, wherein the refractive index of the optical adhesive layer is greater than or equal to 1.40 and less than or equal to 1.51.

25. The display apparatus according to claim 20, wherein the display panel has a display surface, and the light source module is disposed on one side of the display panel facing away from the display surface.
